(19) United States
(12) Patent Application Publication
(10) Pub. No.: US 2012/0093014 A1
(43) Pub. Date: Apr. 19, 2012

(54) COMMUNICAITON METHOD AND APPARATUS USING SYMBOL INTERLEAVING

(75) Inventors: Tae Chul Hong, Daejeon (KR); Hee Wook Kim, Daejeon (KR); Seung Hyun Nam, Daejeon (KR); Kun Seok Kang, Daejeon (KR); Bon Jun Ku, Daejeon (KR); Do Seob Ahn, Daejeon (KR); Sung Moon Yeo, Jeonju-si (KR); Soo Young Kim, Daejeon (KR)

(73) Assignees: INDUSTRIAL COOPERATION FOUNDATION CHONBUK NATIONAL UNIVERSITY, Jeonju-si (KR); ELECTRONICS AND TELECOMMUNICATIONS RESEARCH INSTITUTE, Daejeon (KR)

(21) Appl. No.: 13/275,970

(22) Filed: Oct. 18, 2011

(30) Foreign Application Priority Data
Oct. 19, 2010 (KR) 10-2010-0102029

(51) Int. Cl. H04L 12/26

(52) U.S. Cl. 370/252

(57) ABSTRACT

A communication method and apparatus using a symbol interleaver in a long term evolution (LTE)-based satellite communication system are provided. The communication method may include determining whether to use an interleaver based on service information, and interleaving the data using the symbol interleaver designed based on interleaver information. Also, the communication method may include generating random data using a timer and interleaving the random data.

### TECHNICAL FIELD

The present invention relates to a communication method and apparatus using a symbol interleaver, and more particularly, to a technology for effectively applying a symbol interleaver in a long term evolution (LTE)-based satellite communication system.

### BACKGROUND ART

In a mobile communication system, a data error may occur according to a channel state. The mobile communication system applies an error correction code or a retransmission technology to reduce or prevent the error.

For example, when a convolution code is used for error correction, data having a random error may be restored whereas a burst error is not easily resolved. That is, when the burst error occurs in data, it is difficult for the mobile communication system to restore the data with an error correction code generated using the convolution code. Here, the random error refers to errors occurring in data, in a scattered manner. A burst error refers to errors successively occurring in a particular part of data.

Therefore, when the burst error occurs in transmitted data, an interleaver may be applied to prevent loss of all successive data. The interleaving refers to a technology of mixing bits of the data to be transmitted according to a predetermined method.

Generally, adaptive modulation and coding (AMC) used in a terrestrial communication system presumes that a current channel state is maintained to be similar to a previous channel state until new feedback information for the AMC is received. However, the satellite communication system has a much longer round trip delay (RTD) than the terrestrial communication system. In particular, the RTD makes it difficult to apply the AMC in the satellite communication system.

Accordingly, there is a desire for a new technology for applying the interleaver to AMC and data communication, in a long term evolution (LTE)-based communication system.

### DISCLOSURE OF INVENTION

### Technical Goals

An aspect of the present invention provides a communication method and apparatus for transmitting and receiving data using a symbol interleaver in a long term evolution (LTE)-based satellite communication system.

### Technical Solutions

According to an aspect of the present invention, there is provided a communication method including determining interleaver information based on resource allocation type information and memory information; symbol-interleaving data using the determined interleaver information; and transmitting the symbol-interleaved data and the interleaver information.

The communication method may further include determining whether to use an interleaver based on service information, wherein the service information may include a service to be provided to a terminal device.

The resource allocation type information may include any one of a type 0, a type 1, and a type 2 that defines a long term evolution (LTE)-based resource allocation type, and the symbol-interleaving may include symbol-interleaving the data using an interleaver having a maximum size of 120 with respect to a single resource block (RB) when the resource allocation type information includes the type 2.

The symbol-interleaving may include symbol-interleaving the data using an interleaver set based on the interleaver information and a timer.

The symbol-interleaving may include determining whether a current mode is an interleaver memory initialization mode based on data stored in a buffer; generating random data according to the determined current mode; and symbol-interleaving the generated random data.

According to another aspect of the present invention, there is provided a communication apparatus including an interleaver use determination unit to determine whether to use an interleaver based on service information; an interleaver information determination unit to determine interleaver information based on resource allocation type information and memory information; a symbol interleaver to symbol-interleave data using the determined interleaver information; and a data transmission unit to transmit the symbol-interleaved data and the interleaver information.

The interleaver use determination unit may determine to use the interleaver when the service information includes a large data transmission service, and may determine not to use the interleaver when the service information includes a real-time interactive service.

The symbol interleaver may include an initialization mode determination unit to determine whether a current mode is an interleaver memory initialization mode based on data stored in a buffer; and a random data generation unit to generate random data according to the determined current mode and symbol-interleave the generated random data.

According to another aspect of the present invention, there is provided a communication method including receiving interleaver information determined based on resource allocation type information and memory information; and deinterleaving data using the received interleaver information.

The communication method may further include receiving interleaver use information determined based on service information.

The communication method may further include storing at least one of modulation and coding scheme (MCS) information, channel information, and packet fragmentation information of the data.

According to another aspect of the present invention, there is provided a terminal device including an information receiving unit to receive interleaver use information determined based on service information and also receive interleaver information determined based on resource allocation type information and memory information; and a deinterleaver to deinterleave data using the received interleaver information.

The terminal device may further include a storage unit to store at least one of modulation and coding scheme (MCS) information, channel information, and packet fragmentation information of the data; and a decoding unit to decode the data using the stored MCS information and the channel information.

The deinterleaver may deinterleave a plurality of packets as the data is fragmented into the plurality of packets, and the decoding unit may decode the plurality of deinterleaved packets based on packet fragmentation information of the deinterleaved packets.

### Effects of the Invention

According to embodiments of the present invention, an interleaver appropriate for conditions of a long term evolution (LTE)-based satellite communication system may be provided based on resource allocation type information, service information, and memory information.

Additionally, according to embodiments of the present invention, a data transmission error may be reduced when adaptive modulation and coding (AMC) is used in the LTE-based satellite communication system.

### BRIEF DESCRIPTION OF DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a structure of a communication apparatus according to an embodiment of the present invention;

FIG. 2 is a block diagram illustrating a detailed structure of the symbol interleaver shown in FIG. 1;

FIG. 3 is a diagram illustrating an operation for determining a size and an interleaving unit (IU) of an interleaver using a convolution symbol interleaver, according to an embodiment of the present invention;

FIG. 4 is a block diagram illustrating an operation of performing symbol-interleaving by fragmenting data according to an embodiment of the present invention;

FIG. 5 is a flowchart illustrating an operation of the communication apparatus shown in FIG. 1;

FIG. 6 is a block diagram illustrating a structure of a terminal device according to an embodiment of the present invention;

FIG. 7 is a diagram illustrating an operation of decoding data using modulation and coding scheme (MCS) information and channel information;

FIG. 8 is a diagram illustrating an operation of setting packet fragmentation information; and

FIGS. 9 and 10 are diagrams illustrating an operation of decoding data using packet fragmentation information.

### BEST MODE FOR CARRYING OUT THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

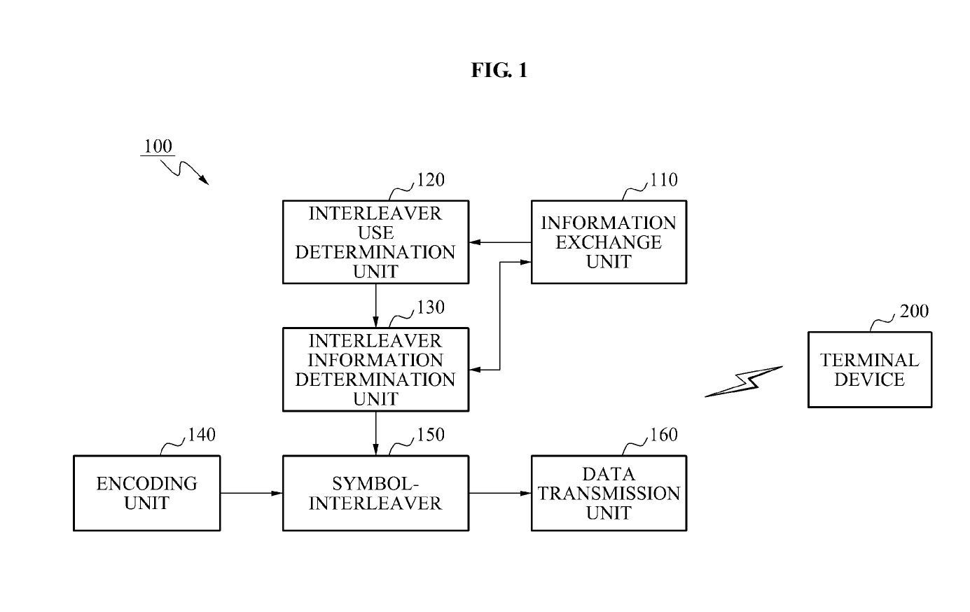

FIG. 1 is a block diagram illustrating a structure of a communication apparatus 100 according to an embodiment of the present invention.

Referring to FIG. 1, the communication apparatus 100 includes an information exchange unit 110, an interleaver use determination unit 120, an interleaver information determination unit 130, an encoding unit 140, a symbol interleaver 150, and a data transmission unit 160. The communication apparatus 100 may further include a base station and a relay for performing data communication with a terminal device 200 that belongs to a long term evolution (LTE)-based satellite communication system.

The information exchange unit 110 may exchange control information necessary to initiate data communication with the terminal device 200. Here, the control information may include at least one of resource allocation type information, memory information of the terminal device 200, and service information.

For example, when the terminal device 200 requests provision of a service, the information exchange unit 110 may receive the service information from the terminal device 200. Here, the service information may include a real-time interactive service such as voice over internet protocol (VoIP), a file transfer protocol (FTP) or a streaming service for transmission of a large amount of data, and a hypertext transfer protocol (HTTP) service. The information exchange unit 110 may receive available memory information of the terminal device 200 from the terminal device 200. In addition, the information exchange unit 110 may transmit the resource allocation type information to the terminal device 200. Here, the resource allocation type information may include a type 0, a type 1, and a type 2 that defines a resource allocation type in an LTE-based communication system.

Here, the type 0 and the type 1 may allocate resources of the same size to one terminal device during one transmit time interval (TTI). That is, as shown in Table 1 below, the type 0 and the type 1 define a number of resource blocks (RB) allocated at one time according to a system bandwidth. According to the type 2, at least one RB is allocated up to a predetermined bandwidth of the whole system to the terminal device 200 during one TTI.

TABLE 1

| System bandwidth | RBG Size (number of RBs) |
|---|---|
| 10 or less | 1 |
| 11~26 | 2 |
| 27~63 | 3 |
| 64~110 | 4 |

According to Table 1, in the type 0 and the type 1, the number of RBs allocated at one time is fixed according to the system bandwidth. Therefore, an interleaver size may be varied according to the bandwidth of the system. Accordingly, the interleaver information determination unit 130 may generate various combinations of interleavers.

The interleaver user determination unit 120 may determine whether to use the interleaver based on the service information.

For example, when the service information includes the real-time interactive service such as the VoIP service and the HTTP service, the interleaver use determination unit 120 may determine not to use the interleaver. When the service information includes a service for large data transmission, such as the FTP service and the streaming service, the interleaver use determination unit 120 may determine to use the interleaver.

The interleaver information determination unit 130 may determine interleaver information based on the resource allocation type information and the memory information. Here, the interleaver information may include at least one of an interleaver size, an interleaving unit (IU), and the interleaver identifier (ID). When the interleaver is determined to be used, the interleaver information determination unit 130 may determine the interleaver information based on the resource allocation type information and the memory information.

First, an operation of determining the interleaver information when the resource allocation type information is the type 0 or the type 1, and transmitting the determined interleaver information to the terminal device 200 will be described.

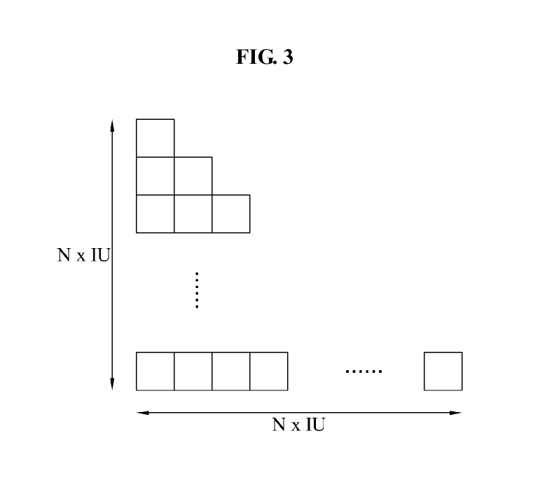

When the resource allocation type information includes the type 0 or the type 1, the interleaver information determination unit 130 may determine the interleaver size N and the IU based on the number of RBs corresponding to the system bandwidth, as shown in Equation 1. Referring to FIG. 3, when the communication apparatus and the terminal device are aware of the interleaver information, that is, information on a number of symbols constituting the IU and a number of the IUs corresponding to the interleaver size, the communication apparatus and the terminal device may interleave and deinterleave data.

N×IU=RB×120 [Equation 1]

In Equation 1, N denotes the interleaver size, IU denotes the interleaving unit, RB denotes the number of allocated RBs, and 120 denotes the number of symbols in the LTE.

According to Equation 1, the interleaver information determination unit 130 may determine the number of RBs corresponding to the system bandwidth as shown in Table 1. In addition, the interleaver information determination unit 130 may determine combinations of the N and the IU resulting from multiplying the determined number of RBs by 120.

For example, when the system bandwidth is 8 and the number of RBs is 1, the interleaver information determination unit 130 may determine the combinations of the N and the IU such that a product of the N and the IU becomes 120. Here, the interleaver information determination unit 130 may determine the interleaver size N to be larger as a memory capacity of the terminal device, included in the memory information, is relatively large. Also, as the memory capacity of the terminal device is relatively small, the interleaver information determination unit 130 may determine the interleaver size N to be smaller. Therefore, the interleaver information determination unit 130 may generate the interleaver information including the interleaver size N and the IU.

In addition, the interleaver information determination unit 130 may interleave the interleaver ID corresponding to the determined interleaver size and IU. Furthermore, the interleaver information determination unit 130 may generate interleaver information including the determined interleaver ID. Here, the interleaver information determination unit 130 may determine the interleaver ID using an interleaving table predefined between the communication apparatus and the terminal device as shown in Table 2 below. Therefore, the information exchange unit 110 may transmit the interleaver information to the terminal device 200. Accordingly, the terminal device 200 may use the same interleaver as the communication apparatus, based on the interleaver information.

TABLE 2

| Interleaver ID | N | IU |
|---|---|---|
| 0001 | 120 | 1 |
| 0010 | 120 | 2 |
| 0011 | 120 | 3 |
| 0100 | 120 | 4 |

According to Table 2, when the RB is 1, N=120 and IU=1 are predefined among various combinations making a product of the N and the IU to be 120. Accordingly, the interleaver information determination unit 130 may generate the interleaver information including the interleaver ID 0001 that corresponds to N=120 and IU=1.

The encoding unit 140 may modulate and encode the data. Here, the encoding unit 140 may generate modulation and coding scheme (MCS) information including a coding rate used for encoding the data.

The symbol interleaver 150 may symbol-interleave the encoded data using the interleaver information. Here, the symbol interleaver 150 may use the interleaver set according to the determined interleaver size and IU. The interleaving refers to mixing of an order of data consisting of bit streams.

Therefore, the data transmission unit 160 may transmit the symbol-interleaved data to the terminal device 200. Here, the data transmission unit 160 may load the MCS information and information for channel estimation, and transmit the loaded information to the terminal device 200.

When the resource allocation type information includes the type 2, the interleaver information determination unit 130 may design the interleaver with respect to a minimum allocable unit for data transmission. Therefore, the symbol interleaver 150 may symbol-interleave the encoded data using the designed interleaver. For example, the interleaver information determination unit 130 may design the interleaver having a maximum size N_{MAX} of about 120 with respect to a single RB which is a minimum unit. Here, when the interleaver is designed with respect to two or more RBs and when one RB is allocated by the base station, data symbols to be input to the interleaver may be insufficient.

As described in the foregoing, when the type 2 is included, since the allocated number of RBs is changeable, the RB may be allocated in various sizes. That is, the interleaver information determination unit 130 may allocate more RBs as a channel state is relatively good and fewer RBs as the channel state is relatively poor. Although the channel state is relatively poor, the interleaver information determination unit 130 may allocate at least one RB as the minimum allocable unit.

Also, the interleaver information determination unit 130 may determine the interleaver size N and the IU using the allocated RB and Equation 1. In a similar manner as in the type 0 and the type 1, the interleaver information determination unit 130 may determine the interleaver size N, based on the memory information, to be large or small. The interleaver information determination unit 130 may determine the interleaver information including the determined interleaver size N and the IU.

Here, in the type 2 as well, the interleaver information determination unit 130 may determine the interleaver information including the interleaver ID using the interleaver table. In this case, the information exchange unit 110 may transmit the determined interleaver information to the terminal device 200.

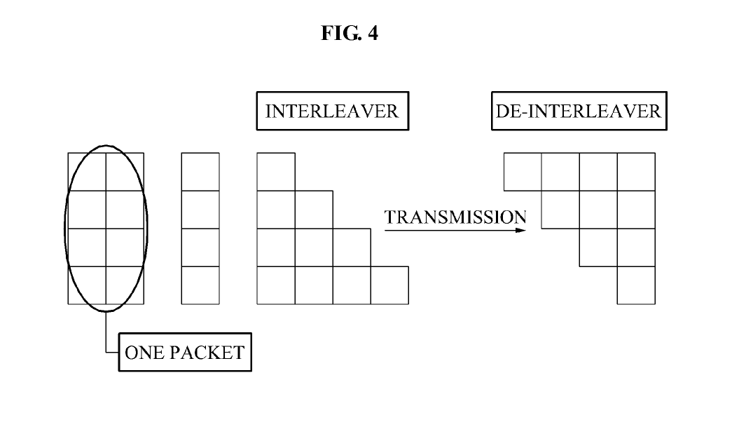

The symbol interleaver 150 may symbol-interleave the encoded data using an interleaver designed based on the determined interleaver size and IU. As shown in FIG. 4, when two RBs are allocated in the type 2, the symbol interleaver 150 may fragment the data into a plurality of packets having a size to be input to the symbol interleaver 150.

In this case, the data transmission unit 160 may load the MCS information and the information for channel estimation on the interleaved data and transmit the data with the loaded information to the terminal device 200.

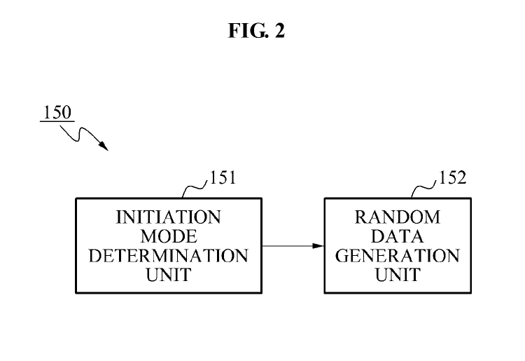

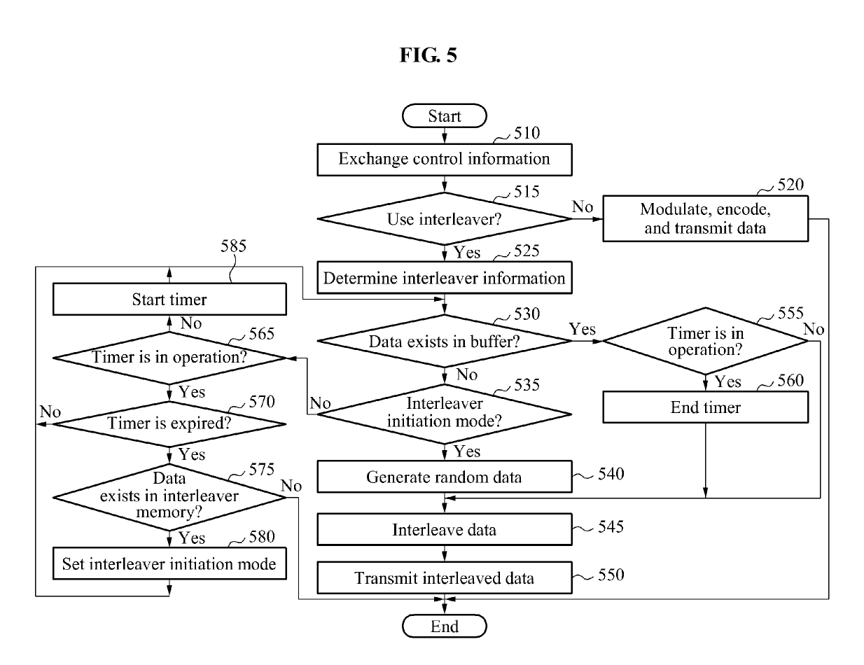

The operation of determining the interleaver information using the resource allocation type information and the memory information has been described thus far. Hereinafter, an operation of performing symbol-interleaving by generating random data using a timer will be described with reference to FIGS. 2 and 5.

FIG. 2 is a block diagram illustrating a detailed structure of the symbol interleaver 150 shown in FIG. 1.

Referring to FIG. 2, the symbol interleaver 150 includes an initialization mode determination unit 151 and a random data generation unit 152.

The initialization mode determination unit 151 may determine whether the symbol interleaver is in an interleaver memory initialization mode, based on data stored in a buffer (not shown). When it is the interleaver memory initialization mode, the random data generation unit 152 may generate random data and symbol-interleave the random data. Next, the data transmission unit 160 may transmit the symbol-interleaved data to the terminal device.

FIG. 5 is a flowchart illustrating an operation of the communication apparatus shown in FIG. 1.

Referring to FIG. 5, the information exchange unit 110 may exchange control information with the terminal device in operation 510. Here, the control information may include at least one of the resource allocation type information, the memory information, and the service information.

In operation 515, the interleaver use determination unit 120 may determine whether to use the interleaver based on the service information.

For example, when the service information includes a service for a large amount of data transmission, the interleaver use determination unit 120 may determine to use the interleaver. When the service information includes real-time interactive service, the interleaver use determination unit 120 may determine not to use the interleaver.

When the interleaver is determined not to be used (515:NO), the encoding unit 140 may modulate and encode data to be transmitted, in operation 520. Therefore, the data transmission unit 160 may transmit the encoded data to the terminal device.

When the interleaver is to determined to be used (515:YES), the interleaver information determination unit 130 may determine the interleaver information using the resource allocation type information and the memory information, in operation 525. Therefore, the information exchange unit 110 may transmit the determined interleaver information to the terminal device. Here, the interleaver information may include at least one of the interleaver size, the IU, and the interleaver ID.

Next, in operation 530, the initialization mode determination unit 151 may confirm whether data exists in the buffer.

When the data is absent in the buffer (530:NO), the initialization mode determination unit 151 may confirm whether the symbol interleaver is in the interleaver initialization mode. For example, when the buffer fails to include data but the symbol interleaver is partially filled with data, the initialization mode determination unit 151 may determine that the symbol interleaver is in the interleaver initialization mode. The interleaver initialization mode refers to an operation mode for initializing the symbol interleaver to transmit the data included in the symbol interleaver when the buffer fails to include the data and a memory of the symbol interleaver partially includes the data.

When the interleaver initialization mode is determined (535:YES), the random data generation unit 152 may generate random data in operation 540. In the type 0 and the type 1 of the resource allocation type, the random data may be generated in a predetermined quantity that may be transmittable at one time. In the type 2, the random data may be generated with respect to a single RB which is the minimum unit. Accordingly, symbol-interleaving may be performed using the data generated by the random data generation unit 152, in operation 545.

Therefore, the data transmission unit 160 may transmit the interleaved data to the terminal device in operation 550. Accordingly, even when the buffer fails to include the data, the communication apparatus 100 may successively transmit the data to the terminal device 200 using the random data. Here, the data transmission unit 160 may transmit data information to the terminal device by loading the data information on the interleaved data. The data information may inform whether the data being transmitted to the terminal device is interleaved random data or interleaved general data. In addition, the data transmission unit 160 may transmit the MCS information and the information for channel estimation by loading the information on the interleaved data.

When the buffer includes the data (530:YES), the initialization mode determination unit 151 may confirm whether a timer is operating in operation 555. When the timer is operating (555:YES), the initialization mode determination unit 151 may end the operation of the timer in operation 560. Therefore, the random data generation unit 152 may input the data stored in the buffer to the symbol interleaver, and symbol-interleave the input data. In addition, the data transmission unit 160 may transmit the interleaved data to the terminal device.

When the symbol interleaver is not in the initialization mode (535:NO), the initialization mode determination unit 151 may confirm whether the timer is operating in operation 565. When the timer is not operating (565:NO), the initialization mode determination unit 151 may confirm whether an interleaver memory includes the data in operation 580. Here, the interleaver memory refers to a memory provided in the symbol-interleaver. When the interleaver memory includes the data (580:YES), the initialization mode determination unit 151 may set the symbol interleaver to the interleaver initialization mode in operation 585.

When the interleaver memory does not include the data, it is considered that transmission of the data to be transmitted is completed. Therefore, the initialization mode determination unit 151 may enter a standby mode until new data to be transmitted is received or end the communication.

As shown in FIG. 5, when the symbol interleaver is used in downlink transmission, when no data is input to to the buffer until the timer, that is a padding bits timer, is expired, the random data may be input to the symbol interleaver and symbol-interleaved. That is, when the buffer does not include the data and the timer is yet to expire, the communication apparatus 100 may control using a scheduler so that the data is not transmitted.

Hereinafter, an operation of a communication apparatus that deinterleaves data using interleaver information received from a base station will be described.

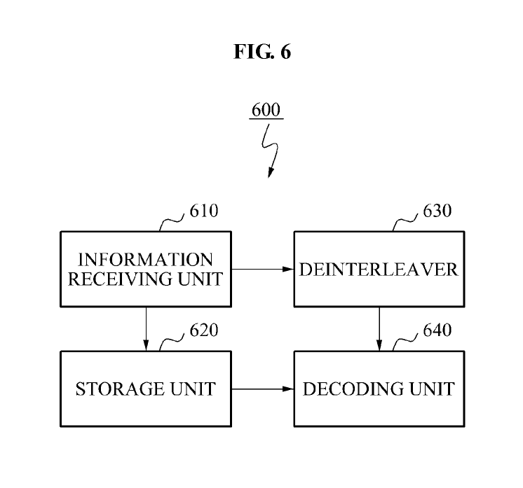

FIG. 6 is a block diagram illustrating a structure of a terminal device according to an embodiment of the present invention.

Referring to FIG. 6, a communication apparatus 600 includes an information receiving unit 610, a storage unit 620, a deinterleaver 630, and a decoding unit 640.

The information receiving unit 610 may receive interleaver information and interleaver use information, which are determined by the base station based on resource allocation type information and memory information of the terminal device. Here, at least one of an interleaver size, an IU, and an interleaver ID may be received as the interleaver information. The interleaver use information may include information on whether to use an interleaver for data transmission. The interleaver use information may be determined by the base station based on service information. The resource allocation type information may include any one of a type 0, a type 1, and a type 2 that defines an LTE-based resource allocation type.

The information receiving unit 610 may receive interleaved data, MCS information, and information for channel estimation.

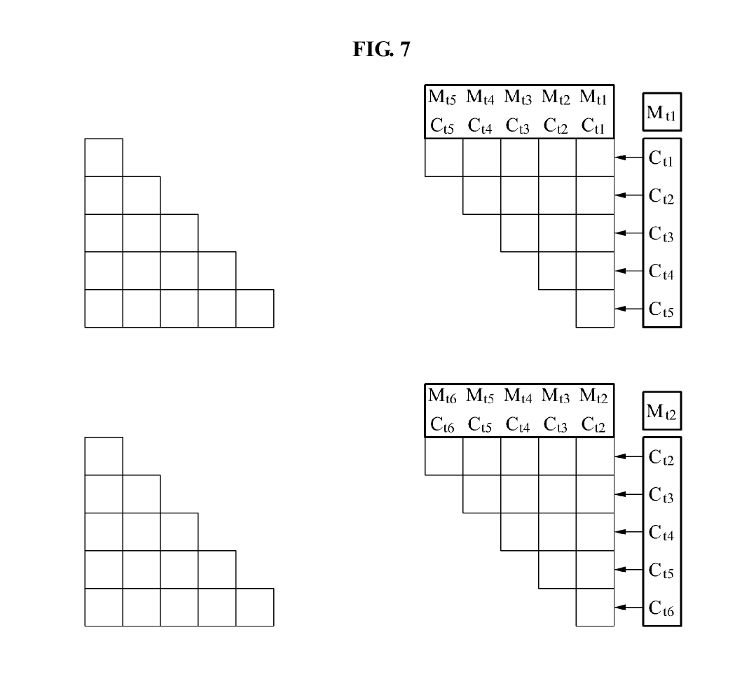

Therefore, the storage unit 620 may store the MCS information and channel information. The channel information is determined based on the information for channel estimation. For example, as shown in FIG. 7, when the data is received, the storage unit 620 may store MCS information Mₜₐ and channel information Cₜₐ of a packet received at time tₐ. In this instance, the MCS information and the channel information corresponding to N times the interleaver sizes need to be stored in the storage unit 620.

The deinterleaver 630 may deinterleave data using a deinterleaver designed based on the interleaver information.

For example, when the interleaver information includes the interleaver ID, the deinterleaver 630 may design a symbol-deinterleaver using an interleaver table predefined with respect to the base station. Also, the deinterleaver 630 may deinterleave the interleaved data using the symbol-deinterleaver.

As another example, when the interleaver information includes the interleaver size and the IU, the deinterleaver 630 may design the symbol-deinterleaver using the interleaver size and the IU.

The decoding unit 640 may decode the deinterleaved data using the MCS information and the channel information. The MCS information is received from the base station and includes information on an MCS used by the deinterleaved data. Here, the decoding unit 640 may demodulate data by log likelihood ratio (LLR) demodulation based on the channel information. Also, the decoding unit 640 may perform decoding based on the MCS information.

As shown in FIG. 4, the base station may transmit a mixture of packets consisting of a plurality of RBs. When the received packets are input to the deinterleaver 630, the storage unit 620 may store packet fragmentation information (SEG). The packet fragmentation information refers to information for discerning whether the packets are fragmented from the same data or different data. The packet fragmentation information may include 1 bit.

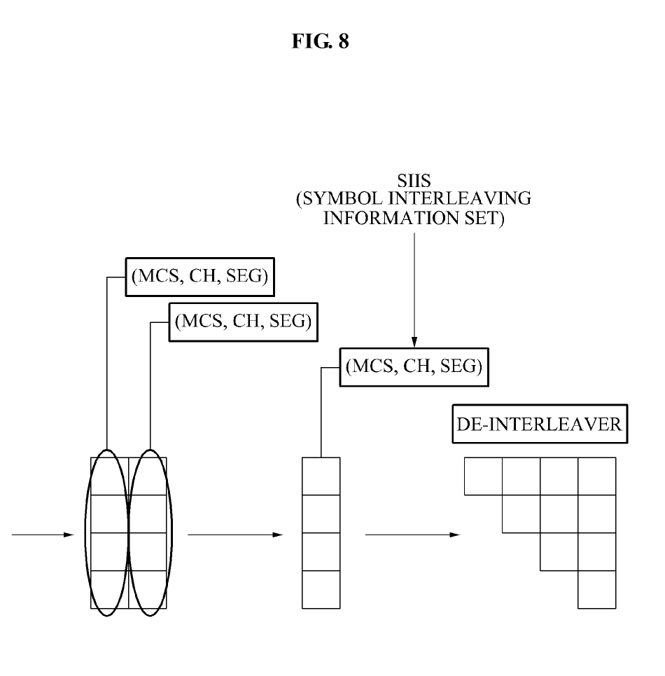

FIG. 8 is a diagram illustrating an operation of setting packet fragmentation information.

Referring to FIG. 8, when a previous packet input to the deinterleaver 630 is fragmented from the same data as a current packet, the storage unit 620 may set and store packet fragmentation information of the current packet as the same value as packet fragmentation information of the previous packet.

For example, when a deinterleaver size corresponds to one RB and when data corresponding to three RBs is transmitted at one time, the deinterleaver 630 may fragment the data into a plurality of packets based on the deinterleaver size. When the data is fragmented into three packets, the storage unit 620 may set and store the packet fragmentation information of the three packets to be the same, for example as 0, 0, and 0. Moreover, the packet fragmentation information of the three packets may be set and stored as 1, 1, and 1.

When the previous packet input to the deinterleaver 630 is fragmented from data different to that of the current packet, the storage unit 620 may set and store the packet fragmentation information of the current packet as a different value from the packet fragmentation information of the previous packet. For example, when the packet fragmentation information of the previous packet is 0, the storage unit 620 may set and store the packet fragmentation information of the current packet as 1. Thus, the storage unit 620 may set and store the packet fragmentation information of the current packet successively input to the deinterleaver as 0 or 1.

Accordingly, the decoding unit 640 may demodulate and decode the deinterleaved packet using the resource allocation type information, the channel information, and the MCS information. That is, when the data input to the deinterleaver corresponds to packets fragmented from the data, the decoding unit 640 may demodulate and decode the deinterleaved packet using the resource allocation type information, not the channel information and the MCS information. When the data input to the deinterleaver fails to correspond to the fragmented packets, the decoding unit 640 may demodulate and decode the interleaved packet using the channel information and the MCS information.

Here, the decoding unit 640 may perform the demodulation and decoding by collecting the plurality of deinterleaved packets using the resource allocation type information.

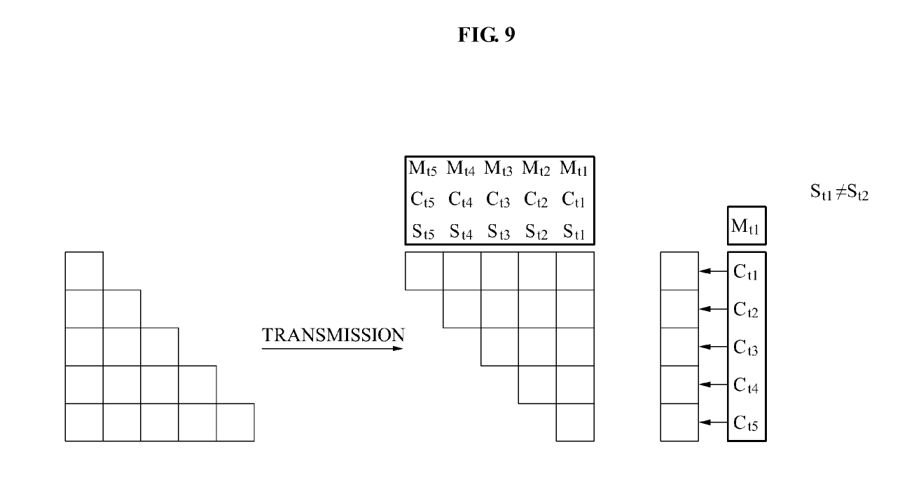

For example, the decoding unit 640 may compare packet fragmentation information Sₜ₁ of the deinterleaved previous packet with packet fragmentation information Sₜ₂ of the deinterleaved current packet, thereby determining whether the previous packet and the current packet are fragmented from the same data. When the packet fragmentation information Sₜ₁ and the packet fragmentation information Sₜ₂ are different as shown in FIG. 9, the decoding unit 640 may demodulate and decode the previous packet and the current packet.

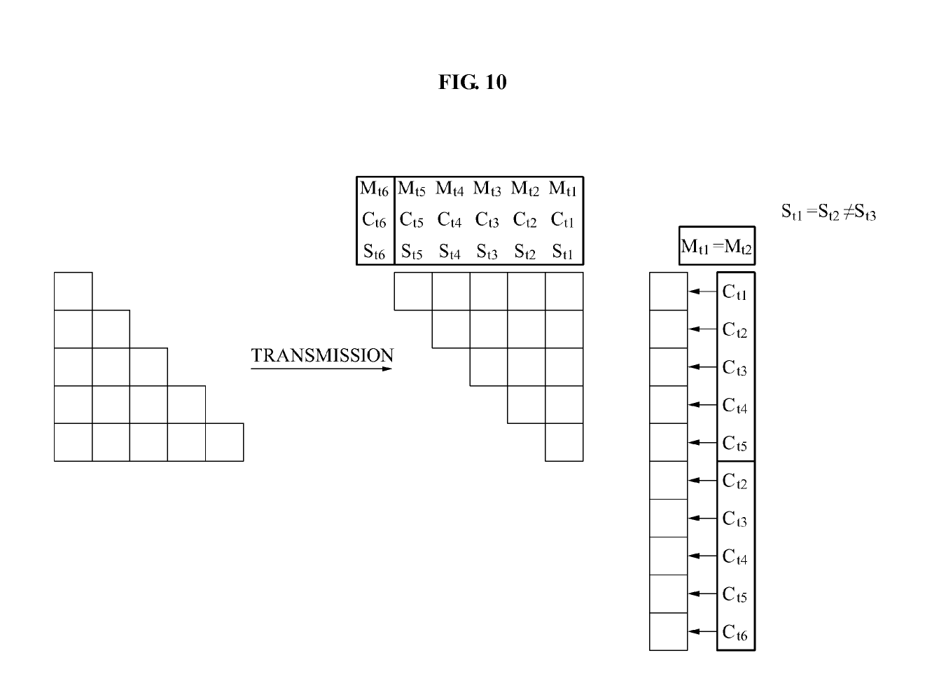

In addition, when the packet fragmentation information Sₜ₁ and the packet fragmentation information Sₜ₂ are the same but packet fragmentation information Sₜ₃ of a next packet is different as shown in FIG. 10, the decoding unit 640 may buffer the previous packet and then demodulate and decode the current packet and the previous packet together after deinterleaving of the current packet is completed. However, the decoding unit 640 may demodulate the previous packet before deinterleaving of the current packet is completed. In this case, the demodulated previous packet and the current packet may be decoded together. Next, the decoding unit 640 may demodulate and decode the next packet separately.

A process of transmitting the data from the base station to the terminal device using the symbol interleaver and a process of restoring the data in the terminal device have been described thus far. However, the foregoing description is suggested only as an example. That is, data interleaved by the symbol interleaver may be transmitted from the terminal device to the base station. Accordingly, the base station may restore the data by deinterleaving the data received from the terminal device.

In addition, the symbol interleaver may be used only in downlink transmission whereas data is transmitted without the symbol interleaver in uplink transmission. That is, the symbol interleaver may be used only when the data is transmitted from the base station to the terminal device.

For example, when the HTTP service is used between the base station and the terminal device, the base station may use the symbol interleaver whereas the terminal device may transmit the data without using the symbol interleaver. That is, the HTTP service transmits small data frequently and irregularly. When an HTTP request message size is about 350 bytes, an HTTP internet page may include 5.6 objects on the average, having about 50 bytes to about 2 megabytes (Mb). When the symbol interleaver having an interleaver size N=120 and IU=1 and quadrature phase shift keying (QPSK) modulation are used, 28.8 kilobits (kbits) may be wasted. In this case, it is inefficient to transmit padding bits of 28.8 bits for transmission of the HTTP request message of 350 bytes (8×350=2.8 kbits). Therefore, when transmitting data from the base station to the terminal device, data interleaved by the symbol interleaver may be transmitted to the terminal device. In addition, when transmitting data from the terminal device to the base station, the symbol interleaver may not be used.

According to the foregoing description, symbol-interleaving is performed in a communication apparatus while deinterleaving is performed in a terminal device. However, this is only an example embodiment. Therefore, symbol-interleaving may be performed in a terminal device while deinterleaving is performed in a communication apparatus. That is, when transmitting data from the terminal device to the communication apparatus, the terminal device may transmit symbol-interleaved data. Therefore, the communication apparatus may deinterleave the received data. Accordingly, the terminal device may transmit interleaver information to the communication apparatus.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. A communication method comprising:
determining interleaver information based on resource allocation type information and memory information;
symbol-interleaving data using the determined interleaver information; and
transmitting the symbol-interleaved data and the interleaver information.

2. The communication method of claim 1, further comprising:
determining whether to use an interleaver based on service information,
wherein the service information comprises a service to be provided to a terminal device.

3. The communication method of claim 2, wherein the determining of whether to use the interleaver comprises:
determining to use the interleaver when the service information comprises a large data transmission service; and
determining not to use the interleaver when the service information comprises real-time interactive service.

4. The communication method of claim 1, wherein
the resource allocation type information includes any one of a type 0, a type 1, and a type 2 that defines a long term evolution (LTE)-based resource allocation type, and
the symbol-interleaving comprises symbol-interleaving the data using an interleaver having a maximum size of 120 with respect to a single resource block (RB) when the resource allocation type information includes the type 2.

5. The communication method of claim 1, wherein
the transmitting of the interleaver information comprises transmitting an interleaver identifier (ID) corresponding to the determined interleaver information, and
the interleaver information includes an interleaver size and interleave unit (IU).

6. The communication method of claim 1, wherein the symbol-interleaving comprises symbol-interleaving the data using an interleaver set based on the interleaver information and a timer.

7. The communication method of claim 1, wherein the symbol-interleaving comprises:
determining whether a current mode is an interleaver memory initialization mode based on data stored in a buffer;
generating random data according to the determined current mode; and
symbol-interleaving the generated random data.

8. A communication apparatus comprising:
an interleaver use determination unit to determine whether to use an interleaver based on service information;
an interleaver information determination unit to determine interleaver information based on resource allocation type information and memory information;
a symbol interleaver to symbol-interleave data using the determined interleaver information; and
a data transmission unit to transmit the symbol-interleaved data and the interleaver information.

9. The communication apparatus of claim 8, wherein
the interleaver use determination unit determines to use the interleaver when the service information includes a large data transmission service, and
the interleaver use determination unit determines not to use the interleaver when the service information includes a real-time interactive service.

10. The communication apparatus of claim 8, wherein the symbol interleaver comprises:
an initialization mode determination unit to determine whether a current mode is an interleaver memory initialization mode based on data stored in a buffer; and
a random data generation unit to generate random data according to the determined current mode and symbol-interleave the generated random data.

11. A communication method comprising:
receiving interleaver information determined based on resource allocation type information and memory information; and
deinterleaving data using the received interleaver information.

12. The communication method of claim 11, further comprising:
receiving interleaver use information determined based on service information.

13. The communication method of claim 11, further comprising:
storing at least one of modulation and coding scheme (MCS) information, channel information, and packet fragmentation information of the data.

14. The communication method of claim 13, wherein the packet fragmentation information comprises 1 bit.

15. The communication method of claim 11, wherein the deinterleaving comprises deinterleaving a plurality of packets as the data is fragmented into the plurality of packets.

16. The communication method of claim 11, wherein
the receiving of the interleaver information comprises receiving an interleaver identifier (ID) corresponding to the determined interleaver information, and
the deinterleaving comprises deinterleaving the data using a deinterleaver set based on the received interleaver ID.

17. A terminal device comprising:
an information receiving unit to receive interleaver use information determined based on service information and also receive interleaver information determined based on resource allocation type information and memory information; and
a deinterleaver to deinterleave data using the received interleaver information.

18. The terminal device of claim 17, further comprising:
a storage unit to store at least one of modulation and coding scheme (MCS) information, channel information, and packet fragmentation information of the data; and
a decoding unit to decode the data using the stored MCS information and the channel information.

19. The terminal device of claim 18, wherein
the storage unit sets and stores packet fragmentation information of a current packet as the same value as packet fragmentation information of a previous packet which is deinterleaved when the previous packet and the current packet are fragmented from the same data, and
the storage unit sets and stores packet the fragmentation information of the current packet as a different value from the packet fragmentation information of the previous packet when the previous packet and the current packet are fragmented from different data.

20. The terminal device of claim 17, wherein
the deinterleaver deinterleaves a plurality of packets as the data is fragmented into the plurality of packets, and
the decoding unit decodes the plurality of deinterleaved packets based on packet fragmentation information of the deinterleaved packets.
